(19) United States
(12) Patent Application Publication
(10) Pub. No.: US 2017/0051195 A1
(43) Pub. Date: Feb. 23, 2017

(54) Surfactant Compositions

(71) Applicant: Cytec Industries Inc., Woodland Park, NJ (US)

(72) Inventors: David VANZIN, Franklin, TN (US); Shailesh MAJMUDAR, Stamford, CT (US); Nimal JAYASURIYA, Shelton, CT (US)

(73) Assignee: Cytec Industries Inc., Woodland Park, NJ (US)

(21) Appl. No.: 15/240,573

(22) Filed: Aug. 18, 2016

(30) Foreign Application Priority Data
Aug. 21, 2015 (EP) 15182089.1

(51) Int. Cl. C09K 8/584; C09K 8/62; E21B 43/20; C09K 8/035

(52) U.S. Cl. CPC C09K 8/584; C09K 8/035; C09K 8/62; E21B 43/20; E21B 43/26

(57) ABSTRACT

The invention relates to a surfactant mixture having at least two different sulfosuccinates, and an additional surfactant selected from the group consisting of alkoxylated aliphatic alcohols, and to a method of treating a hydrocarbon oil containing formation by injection of solutions including mixtures of these surfactants.

### CROSS-REFERENCE TO RELATED APPLICATIONS

This application claims benefit of priority of EP Application No. 15182089.1 filed Aug. 21, 2015, which is incorporated herein by reference in its entirety.

### FIELD OF THE INVENTION

This invention relates to surfactant compositions that are used to prepare solutions having both low surface tension and low interfacial tension in contact with hydrophobic fluids, which can be preferably used in paints and coating compositions, adhesives, overprint varnishes, building and construction, metalworking fluids, surface cleaners, and synthesis of polymer dispersions and emulsions, and particularly in oil field applications, such as drilling muds, oil field dispersants, oil field wetting agents, and specifically, for enhanced oil recovery and hydraulic fracturing. It also relates to processes to recover hydrocarbon oils from subterranean reservoirs using these surfactant compositions.

### BACKGROUND OF THE INVENTION

Crude oil is typically recovered from oil bearing reservoirs by three processes, generally categorized as primary, secondary or tertiary recovery. In primary recovery, the oil is produced through a producing well by taking advantage of the pressure exerted by underground pools of water and gas or by water present in the oil. Approximately, only 20% of the original oil in place (OOIP) is recovered by this process. Once this pressure has been exhausted, other means of recovery of the remaining oil must be employed. In secondary recovery, the well may be re-pressurised with gas or water injected through one of the injection wells to recover an additional 20% of the OOIP. Other secondary recovery methods including acidising and/or fracturing to create multiple channels through which the oil may flow. After secondary recovery means have been exhausted and are failing to produce any additional oil, tertiary recovery can be employed to recover additional oil which amounts up to approximately 60% of the OOIP. Tertiary recovery processes include, but are not limited to, steam flooding, polymer flooding, microbial flooding and chemical flooding.

Within the oil containing reservoir, there are a number of factors which can influence the amount of oil recovered. Many of these factors are related to the water utilised in the flood and its interaction with the oil and the rock surfaces within the reservoir formation. It is often common practice to incorporate surfactants into the secondary and tertiary recovery processes to assist in lowering the surface tension of the water to more effectively wet the formation and to lower the interfacial tension between the water and the oil to more effectively release the oil. The ability of the water to possess lower surface tension is a desired effect as it allows the water to come into intimate contact with the rocks in the formation, essentially modifying their wettability and easing and improving the release and extraction of the oil. By lowering the surface tension of aqueous liquids, solid matter can be more easily wet out by the liquid. This property is useful when treating subterranean formations with various aqueous liquids to stimulate the flow of petroleum and/or aqueous fluids therefrom. Low surface tension in combination with the water wetting properties of an aqueous liquid reduces the capillary forces in the formation being treated. Reduction in the capillary forces in a reservoir results in a more effective recovery of fluids after the formation has been treated.

It is also well known that lowering the interfacial tension between the water and the oil is a greatly desired effect as this lower interfacial tension allows for the water and oil to come into intimate contact and for the oil to be released into the water flood stream and flow to the production well where it can be recovered.

In many enhanced oil recovery operations, the source of the water is brine and this brine may contain various metal ions such as sodium, calcium, magnesium and others. The use of surfactants to reduce the surface and interfacial tension between the water and the oil to be displaced from the formation is well known and the literature is replete with different surfactants and combinations thereof useful in water flooding processes. It is well known that the effectiveness of any given surfactant material varies considerably with such factors as temperature of the water, the amount of salt in the water, the amount and type of metal ions in the water and the like. Additionally, the rock formation itself, limestone or sandstone can influence surfactant selection and performance as well as the nature and type of the oil being extracted. Precipitation of surfactant leads to a loss in the efficiency of recovery as the surfactant no longer can serve to wet the formation and lower interfacial tension. Additionally, the surfactant precipitate can plug channels within the formation, decreasing formation porosity and injectivity, thereby causing a substantial decrease in oil displacement efficiency.

These oil recovery techniques typically employ significant quantities of water in combinations with steam, polymers, microbes and chemicals. In secondary and tertiary recovery, the fluid is injected into one or more injection wells and passes into the formation. Oil is then displaced within the formation and moves through the formation and is produced at one or more production wells.

Secondary and tertiary recovery is enhanced through the incorporation of surfactants that assist in improving the microscopic displacement of oil within the subterranean formation. The surfactants increase and improve the miscibility of the water and the oil in the formation to form disperse phases, assisting in its release and recovery. This is because the surfactant lowers the interfacial tension between the water and the oil and in some cases the unfavourable contact angle made by the interface of the two liquids and the solid surface. As a result, the water is able to penetrate the micropores and other smaller pores in the formation and improve recovery of the oil. Thus, the microscopic sweep efficiency of the tertiary fluid is enhanced, as the amount of oil displaced out of the pore space of the portion of the formation through which the flooding liquid approaches the original amount of oil therein.

The current art details the usage of many types of surfactants to lower either surface or interfacial tension in enhanced oil recovery and fracking operations. Some of the types of surfactants detailed in the art as generating low surface and interfacial tension include anionics, cationics, amphoterics and nonionics. Specific chemical classes would include alkyl sulfonates, alkyl aryl sulfonates, alkyl diphenyl ether disulfonates, aryl sulfonates, alphaolefin sulfonates, petroleum sulfonates, alkyl sulfates, alkylether sulfates, alkylarylether sulfates, ethoxylated and propoxylated alcohols, fluorosurfactants, sorbitan and ethoxylated sorbitan esters, glucose esters, polyglucosides, phosphate esters, amine oxides, alkyl amido betaines, imidazolines, sulfosuccinates and blends of these materials.

In U.S. Pat. No. 3,333,634 A, an aqueous system to enhance oil recovery is disclosed which comprises a mass fraction of from 0.02% to 1.5% of an alkyl aryl oxy poly(ethyleneoxy) ethanol in combination with a mass fraction of from 0.02% to 1% of sulfosuccinate in brine solutions having a mass fraction of sodium chloride of up to 2.5%. In U.S. Pat. No. 3,346,047 A, stepwise flooding is disclosed with the above surfactant systems, first at a high concentration in a nonsaline solution, next at a lower concentration in a saline solution, and finally with a brine solution without surfactant addition. In U.S. Pat. No. 3,811,504 A, a three-component surfactant system is described based on a combination of a water soluble salt of an alkyl or alkyl arylsulfonate anionic surfactant plus a water soluble salt of an alkyl polyoxyethoxy sulfate anionic surfactant plus a nonionic surfactant such as a polyethoxylated alkyl phenol, a polyethoxylated aliphatic alcohol or a fatty acid mono or dialkanolamide. These systems are functional in enhancing oil recovery in brine solutions with a mass fraction of electrolyte of up to 1.2%, at surfactant concentrations of from 0.6% to 1.5%. In U.S. Pat. No. 3,827,497 A and 3,890,239 A, detail enhanced oil recovery with a brine based system containing an organic sulfonate surfactant, a sulfated or sulfonated oxyalkylated alcohol and a polyalkylene glycol alkyl ether. The mass fraction of surfactant in the aqueous phase is from 4% to 28%, for a brine having a mass fraction of from 0.5% up to 8% of NaCl, and from 50 mg/kg up to 5 g/kg of polyvalent ions such as Ca²⁺ and Mg²⁺. In U.S. Pat. No. 4,018,689 A, the usage of perfluorinated surfactants is described in combination with sodium di-2ethylhexyl sulfosuccinate and an ethoxylated (with an average of five oxyethylene groups per molecule) trimethyl-1-heptanol to yield low surface tension for acidising hydraulic fracturing fluid formulations. U.S. Pat. No. 4,825,950 relates to an enhanced oil recovery system based on anionic and amphoteric surfactants, a polymeric thickener, and other polymeric materials. The surfactants detailed in the patent are alpha olefin sulfonates and betaines. At a mass fraction of surfactants of 0.25%, the interfacial tension for the surfactants alone in seawater was 0.01 mN/m and only subsequently lowered by addition of the polymeric materials. U.S. Pat. No. 7,137,447 relates to a method of treating a hydrocarbon containing formation with a hydrocarbon recovery composition comprising an aliphatic anionic surfactant which is preferably an alkane sulfate, and an aliphatic nonionic additive which is preferably a long chain aliphatic alcohol. In some examples, the aliphatic nonionic additive is sorbitan laurate. In U.S. Pat. No. 7,373,977 B1, a process for oil recovery is described using an amphoteric alkyl amido betaine surfactant, alone or in combination with additional surfactants which are either an anionic, cationic or non-ionic, at mass fractions of betaine of from 0.15% to 10%, and mass fraction of additional surfactants of from 0.01% to 5%, in the aqueous injection fluid, to achieve low interfacial tension and increased viscosity. It is also taught that the composition of the formulation has to be varied dependent upon the source of the oil. From U.S. Pat. No. 7,482,310 B1, a hydraulic fracturing fluid has been known which contains a water-in-oil emulsion composition (I) that includes a water-in-oil emulsion (i) of a polymer or copolymer with repeat units from acrylamide monomer, a carrier solvent (ii) and a fluidising agent (iii), and inorganic microparticles (iv). This water-in-oil emulsion is then added to water to form a fracturing fluid. The cited surfactants include C₂- to C₂₄— linear, branched, and cyclic alkyl phenol ethoxylates, C₂- to C₂₄— linear, branched, and cyclic alkyl ethoxylates, alkyl sulfonates, alkyl aryl sulfonates, such as the salts of dodecyl-benzene sulfonic acid, alkyltrimethyl aluminium chloride, branched alkyl ethoxylated alcohols, cocobetaines, dioctyl sodium sulfosuccinate, imidazolines, alpha olefin sulfonates, linear alkyl ethoxylated alcohols and trialkyl benzylammonium chloride. In U.S. Pat. No. 7,556,098 B2, usage of mixtures of amphoteric alkyl amido betaine surfactants is described at mass fractions of surfactants of from 0.02% to 5% in brines having mass fractions of dissolved sodium chloride of from 0.5% to 20%, to achieve low interfacial tension of less than 0.01 mN/m. However, no mention is made to the surface tension lowering properties of these systems. In the published patent application US 2008/0302531A1, injection fluids are described that comprise primary surfactants and co-surfactants in combination with solvents, alkalis and viscosifiers to achieve enhanced oil recovery. The surfactants include an aryl alkyl sulfonate as primary surfactant, and a co-surfactant such as an alcohol ether, alcohol ether sulfate, alcohol ether sulfonate, alkoxylated phenols, alkoxylated phenol sulfates, alkoxylated phenol sulfonates, alkoxylated fatty acids, glucose esters, polyglucosides, phosphate esters, alkyl diphenyl ether sulfonates, amine oxides, sulfosuccinates, olefin sulfonates, alkane sulfonates, alkyl aryl sulfonates and others. Co-surfactants are chosen to act synergistically with the primary surfactant giving lower IFT than the primary surfactant alone and also to broaden the tolerance to the formulation with respect to low IFT over a range of total dissolved solids. The mass fraction of primary surfactant in the injection fluid is from 0.025% to 5%, and the mass fraction of co-surfactant is up to 5%, resulting in a range of interfacial tension below 0.01 mN/m, at a mass fraction of dissolved solids in the brine of 4.7 g/kg and 12 g/kg (0.5% and 1.2%). US published patent application 2011/0174485 A1 relates to a method for improving oil and gas production by employing a treatment fluid comprising mixed surfactants to treat formations comprising multiple rocks. The invention involves a base fluid, a first surfactant having one charge, a second surfactant having an opposite charge, and a compatibiliser, and introducing the treatment fluid into at least a portion of the reservoir. The first surfactant is a cationic surfactant and the second surfactant is an anionic surfactant. The compatibiliser is a non-ionic surfactant. It is disclosed that mixed surfactants lower the surface tension, are more tolerant to salts, and offer better foaming. The base fluid may be fresh water, salt water, brine, seawater or a combination. US published patent application 2014/0262286 A1 relates to a multicomponent surfactant system to remediate and recover additional oil from wells that have undergone secondary and tertiary oil recovery and have suffered some damage that has now slowed the oil flow. This invention helps in restoring the well. The surfactants include a C₂₀- to C₂₈— internal alphaolefin sulfonate and two or more chemicals selected from the group of a C₁₅- to C₁₈— alphaolefin sulfonate, an alcohol alkoxylated sulfate, an alcohol alkoxylated carboxylate and a diester sulfosuccinate. Mass fraction of each of surfactants may vary from 0.1% to 25%. WO 2009/130141 A1 relates to the use of a surfactant mixture for tertiary oil recovery, which mixture comprises at least one surfactant having a hydrophilic group which preferably a sulfonate group, and a hydrocarbon radical with from twelve to thirty carbon atoms, and at least one cosurfactant according to the formula R²—O—(R³—O)ₙ—R⁴, where R² is a branched hydro-carbyl residue with from six to eleven carbon atoms, R³ is an ethylene group —CH₂—CH₂—, or a propylene group —CH(CH₃)—CH₂—, or both, and n is from 2 to 20. Sulfosuccinates are not mentioned. In the international application WO 2011/045 204 A1, a method for the recovery of oil is disclosed where a surfactant mixture is used which comprises at least one surfactant A of formula R¹—O—(CH₂—CH₂—O)ₓ—H, where R¹ is a straight chain or branched aliphatic or aromatic hydrocarbon radical with from eight to thirty-two carbon atoms, and x is from 11 to 40, and at least one surfactant B which is different from A and has the formula R²—Y, where R² is a straight chain or branched aliphatic or aromatic hydrocarbon radical with from eight to thirty-two carbon atoms, and Y is a hydrophilic group which can be sulfate and sulfonate groups, polyoxyalkylene groups which may also be anionically amodified, betainic groups, glucoside groups, or aminoxide groups. Sulfosuccinates are not mentioned.

It is documented in the prior art that sulfosuccinates can be combined with other surfactants to achieve either low surface or low interfacial tension in oil recovery operations, see US 2014/0 262 286 A1. However, there exists no art that describes how differing sulfosuccinates can be optimally combined to achieve synergistic performance and offer the feature of both low surface and low interfacial tension in the same formulations. In the selection of surfactants for enhanced oil recovery applications, the oil and conditions of the reservoir can greatly influence surfactant selection and performance. In selecting surfactants that will serve to lower both surface and interfacial tension, one must examine the performance of the surfactants in formulations and environments that will approximate the end use application. Selection of a surfactant to lower surface and interfacial tension is influenced by surfactant chemistry, brine composition, nature of the porous media, temperature and pressure. Ideally, one is looking for a surfactant system that exhibits good solubility in the brine at surface and reservoir conditions, has appropriate thermal stability under reservoir conditions and has a low adsorption onto the reservoir rock.

Some of the weaknesses of surfactants covered by the prior art include: (1) may be good for reducing surface tension (i.e. wetting) or lowering interfacial tension (improving oil release/recovery) but not offering both properties in the same formulation; (2) functionality is limited to specific types of oils and reservoirs; (3) effective concentration ranges of the surfactant is too narrow; (4) lack of high temperature stability and functionality; (5) the surfactant is not readily dispersible or soluble in the formation brine; (6) the flash point of the surfactant is low, creating hazards and additional expenses for transfer, storage, mixing and special handling; (7) high surfactant adsorption onto the formation; and (8) the surfactant is manufactured from materials that are in short supply and not readily available for full scale manufacture.

In addition to the surfactants, it is common practice to utilise aqueous solvents to enhance the recovery of the oil. The aqueous solvents may be water, oilfield brine or synthetic brine. Additionally, it is common to incorporate alkalis, thickening agents and co-solvents to the formulation. Non-exclusive examples of suitable alkalis are sodium hydroxide, sodium carbonate, sodium silicate, potassium hydroxide, and potassium carbonate. Non-exclusive examples of thickening agents include polymers such as xanthan gum, polyacrylamide or viscoelastic surfactants such as betaines and amine oxides. Non-exclusive examples of suitable co-solvents include low molar mass alcohols, glycols, polyglycols, and glycol ethers such as propylene glycol, ethylene glycol, diethylene glycol, isopropanol, butanol, iso-butanol, hexanol, 2-ethyl hexanol, octanol and ethylene glycol monobutyl ether.

While the prior art does include references to using sulfosuccinates in combination with other anionic, cationic and non-ionic surfactants in secondary (hydraulic fracturing) and tertiary oil recovery, their usage has been limited due product solubility, stability, functionality and handling. Specifically, with respect to sulfosuccinate product functionality, the ability of the products to perform in varying reservoirs and lower both surface and interfacial tension, with various types of oil, a range of brine concentrations and over a range of temperatures has been limited.

Thus, there exists a need in the market for a surfactant system that could be broadly applicable to both secondary (i.e. hydraulic fracturing and water flooding) and tertiary oil recovery. Such a surfactant system would need to offer both lower surface tension than water which is 72 mN/m at 25° C., preferably less than 30 mN/m, which would facilitate its ready wetting out of the rock formation, and at the same time, low (less than 10 mN/m) to ultra-low (less than 0.10 mN/m) interfacial tension in contact with hydrocarbon oil allowing it to more easily release oil entrapped within the rock. The system should be functional with different, varying oils as might be found in various subterranean formations around the world. The system should be readily dispersible and soluble in water and a range of brines and be able to function over a broad range of temperatures (e. g. from 5° C. to 80° C.). The products should be functional at a concentration where they impart both the properties of low surface tension and low interfacial tension. The surfactants should not be readily absorbed onto rocks in the subterranean formation. It would also be highly advantageous if the surfactants systems were safe and easy to handle.

### SUMMARY OF THE INVENTION

It has been found, in the course of the experiments leading to the invention, that sulfosuccinate surfactants can be blended among themselves and additionally, with other surfactants to yield surfactant compositions which are synergistic systems that offer low surface tension, low interfacial tension and, for select products, both low surface and low interfacial tension. The formulated products are also functional over a broad range of temperature and salinity and select products evidenced increased solubility and compatibility in select brine systems. Product performance can be optimised, by adapting the amounts of individual surfactants within the composition, for a given oil and set of oil field conditions.

It has been shown in the experiments on which this invention is based that surfactant compositions comprising mixtures of at least two diester sulfosuccinate surfactants and at least one aliphatic alcohol alkoxylate having an HLB value of more than 6.2 when combined in various ratios for a given oil and salinity offer low surface tension and low (less than 10 mN/m) to ultra-low (equal to or less than 0.10 mN/m) interfacial tension. These surfactant compositions offer both low surface and interfacial tensions, already at low concentrations, and functionality over a range of salinities and temperatures. Select systems will additionally offer enhanced and improved product solubility and safer and better handling products.

The invention therefore provides a surfactant mixture M comprising at least two different sulfosuccinates S1 and S2, S1 having the formula R¹—O—CO—CHX—CHY—CO—O—R², R¹ and R² are linear or branched alkyl groups having independently from each other, from four to six carbon atoms, and S2 having the formula R³—O—CO—CHX—CHY—CO—O—R⁴, where R³ and R⁴ are linear or branched alkyl groups having independently from each other, from seven to forty carbon atoms, and for both formulae independently, X is —H and Y is —SO₃⁻, or Y is —H and X is —SO₃⁻. This surfactant mixture M comprises, in addition to S1 and S2, at least one further surfactant S3 which is selected from the group consisting of alkoxylated aliphatic alcohols having from eight to forty carbon atoms in the alcohol part, and a HLB value of more than 6.2, wherein the oxyalkylene groups are ethyleneoxy groups —CH₂—CH₂—O— or propylenoxy groups —CH(CH₃)—CH₂—O—, or mixtures of these, and wherein the alcohol part is a single alcohol having from eight to forty carbon atoms, or a mixture of at least two of such alcohols.

The invention also provides a surfactant composition which is an aqueous solution of the surfactant mixture M. This aqueous solution may also comprise dissolved salts, particularly sodium chloride, also in combination with salts of other metals such as Mg, Ca, K and Sr, and anions such as sulfate, bicarbonate, bromide, borate, and fluoride. Such aqueous salt solutions are generally referred to as brine. Aqueous solutions of the surfactant mixture M usually have mass fractions of dissolved surfactant mixture of up to 20% (200 g/kg), preferably from 0.1% to 5%, and can directly be used as injection fluids, particularly in supplemental oil recovery processes.

The invention further provides a solution of the surfactant mixture M in a mixture of water and organic solvents selected from aliphatic monohydric or dihydric alcohols which may optionally be substituted, particularly ethanol and isopropanol as monohydric alcohols, and ethylene glycol and propylene glycol as dihydric alcohols, mixtures of these alcohols, mixed aliphatic-aromatic solvents such as solvent naphtha, or toluene, xylene isomers, and other alkylbenzenes, and liquid paraffins such as heptane, isooctane, decane, and isoparaffins which are synthetic linear and branched paraffin mixtures having from nine to fourteen carbon atoms, and a boiling temperature range of from 170° C. to 220° C.

Solutions in aliphatic alcohols which may optionally be substituted, or in optionally substituted aliphatic alcohols mixed with water, with a mass fraction of the mixture of dissolved surfactants of from 5% to 90%, particularly 15% to 85%, are preferred. Such concentrated solutions can be used with preference as master formulations, which can be diluted with water or brine to the working concentration, corresponding to a mass fraction of surfactants in the injection solution of preferably from 0.1% to 5%, immediately before application.

The invention also provides a method of use of such surfactant mixtures M in supplemental oil recovery comprising dissolving the surfactant mixture M in an organic solvent, or water or brine, or mixtures of these, to form a solution preferably having a mass fraction of surfactants in the solution of from 0.1% to 5% and injecting the solution thus formed as injection fluid into an oil-bearing geological formation, via a so-called injection well, optionally followed by injecting water or brine, and collecting the oil displaced by the injected fluids in a production well.

### DETAILED DESCRIPTION OF THE PREFERRED EMBODIMENTS

In a preferred embodiment, the alkyl groups R¹ and R² in S1 are identical, and are selected from the group consisting of n-butyl, 1-methylpropyl, 2-methylpropyl, 1,1-dimethylethyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methypentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, and 2-ethylbutyl.

In a further preferred embodiment, the alkyl groups R³ and R⁴ in S2 are identical, and are selected from the group consisting of linear alkyl groups, and monobranched and multiply branched alkyl groups having from seven to forty carbon atoms, preferably seven to twenty carbon atoms, which alkyl groups are derived from aliphatic alcohols made by diverse processes including hydrogenation of mixtures of fatty acids, or from olefins using Ziegler alcohol processes, by the Guerbet reaction with mixtures of primary alcohols, by aldol condensation and subsequent hydrogenation, or by the oxo process with subsequent hydrogenation of the aldehydes formed. Among the preferred alkyl groups, mention is made of n-heptyl, branched heptyl such as those alkyl groups derived from heptanol mixtures made by hydroformylation of isohexene which is the dimerisation product of propene, n-octyl and branched octyl, particularly 2-ethylhexyl, and the isooctyl isomer mixture derived from isooctyl alcohol made by codimerisation of butene and propene and subsequent hydro-formylation, 2,6-dimethyl-4-heptyl where the corresponding alcohol is made by aldol condensation of acetone and subsequent hydrogenation, multiply branched nonyl such as the isomer mixture derived from the isononanol made by dimerisation of isobutene or codimerisation of 1-butene and 2-butene, and subjecting this dimers to oxo synthesis, n-decyl, the multibranched decyl group which is a mixture of isomeric trimethylheptyl and 3,5-dimethyloctyl, where the corresponding alcohol is made by hydroformylation of the propene trimer, alpha-branched primary dodecyl which is derived from the Guerbet alcohol made by condensation of n-hexanol, particularly branched tridecyl which a mixture of isomeric branched primary tridecyl groups, where the corresponding alcohol is made by oxo synthesis from tetrapropylene, iso-hexadecyl which is a mixture of dialkylethyl with branched C₆ and C₈ units, alpha-branched hexadecyl which is derived from 2-hexyldecanol made by the Guerbet reaction, iso-octadecyl which is a mixture of highly branched primary alkyl where the main component is 5,7,7-trimethyl-2-(1,3,3-trimethylbutyl)-octyl, and alpha-branched eicosyl which is derived from 2-octyldodecanol made by the Guerbet reaction, and also of mixtures of alkyl groups of differing numbers of carbon atoms such as those derived from isomer mixtures of aliphatic linear and branched alcohols having from nine to forty carbon atoms based on fatty alcohols which are made by hydrogenation of mixtures of fatty acids, or from olefins using Ziegler alcohol processes, by the Guerbet reaction with mixtures of primary alcohols, or by the oxo process.

The cation of these sulfosuccinates is mostly sodium, although other alkali metals and earth alkali metals such as lithium, potassium, magnesium, calcium, or also ammonium or alkylammonium such as tetramethylammonium, or mixtures of these cations, can also be used.

Particularly preferred are mixtures of sodium di-(1,3-dimethylbutyl)-sulfosuccinate, sodium diisobutyl-sulfosuccinate, or sodium diamyl-sulfosuccinate, as S1, and sodium bis-tridecyl-sulfosuccinate or sodium dioctylsulfosuccinate which comprises mostly the 2-ethylhexyl isomer, as S2. It is, of course, also possible to use two or more surfactants for S1 or for S2, or for both S1 and S2. Such diester-sulfosuccinates are commercially available from Cytec Industries Inc., e. g. as solutions in mixtures of propylene glycol and water, under the trade names of AEROSOL® MA-80 PG and AEROSOL® OT-70 PG.

Further preferred are mixtures comprising as component S1, sodium di-(1,3-dimethylbutyl)-sulfosuccinate, sodium diisobutyl-sulfosuccinate, or sodium diamyl-sulfosuccinate, and as component S2, sodium dioctylsulfosuccinate which comprises mostly the 2-ethylhexyl isomer, or sodium bis-tridecyl-sulfosuccinate, where the tridecyl alcohol used is n-tridecanol, or preferably the branched isomer mixture of tridecanol available from tetrapropylene in an oxo process, and as component S3, an alkoxylated aliphatic alcohol surfactant which has a HLB value of more than 6.2, such as at least 6.5, at least 7, or at least 8, or at least 9. The best results have been obtained for alkoxylated alcohol surfactants having a HLB of at least 10, more preferably, at least 11.

It is also possible to use a monoester sulfosuccinate S4, in combination with surfactants S1 and S2. These monoester sulfosuccinates are anionic surfactants having, on average, one carboxylate group —COO⁻, one sulfonate group SO3⁻, and one carboxylic ester group in their molecule, where the alcohol component of the ester can preferably be selected from linear or branched aliphatic alcohols having from eight to forty, preferably up to twenty, carbon atoms in their molecule, from alkoxylated linear or branched aliphatic alcohols having from eight to forty, preferably up to twenty, carbon atoms in the alcohol part of their molecule, comprising at least two oxalkylene ether segments which are preferably derived from oxyethylene and oxypropylene groups, or their mixtures, particularly preferred, predominantly or exclusively oxyethylene groups, or from N-hydroxyethyl fatty acid amides where the fatty acid has from six to thirty carbon atoms. Particularly preferred are alkali and earth alkali salts of these mentioned sulfosuccinic acid monoesters. Mixtures two or more of such monoester sulfosuccinates can also be used. It is, of course, possible to use both surfactants S3 and S4 in combination with the mixture of surfactants S1 and S2.

Also preferred are mixtures comprising as component S1, sodium di-(1,3-dimethylbutyl)-sulfosuccinate, sodium diisobutyl-sulfosuccinate, or sodium diamyl-sulfosuccinate, and as component S2, sodium dioctylsulfosuccinate which comprises mostly the 2-ethylhexyl isomer, or sodium bis-tridecyl-sulfosuccinate, where the tridecyl alcohol used is linear tridecanol, or preferably branched tridecanol, and as component S3, an alkoxylated aliphatic alcohol, or a mixture of such alkoxylated aliphatic alcohols, having from eight to forty carbon atoms in the alcohol part, and wherein the alkoxy groups are ethyleneoxy groups —CH₂—CH₂—O— or propylenoxy groups —CH(CH₃)—CH₂—O—, or mixtures of these, and wherein the alcohol part of component S3 is a single linear or branched aliphatic alcohol, or a mixture of at least two of such alcohols which preferably have from nine to twenty carbon atoms. These alcohols can be made in reactions as those cited in the explanation of the preferred compounds S2. Particularly preferred are such mixtures where the alkoxylated aliphatic alcohol S3 has a HLB value of at least 8. It is also possible to use mixtures of two or more surfactants S3. The preferred minimum HLB number is then that of the mixture of these two or more surfactants S3.

The surfactant mixtures M comprising components S1, S2, and S3 which is an alkoxylated aliphatic alcohol as defined hereinabove, are particularly useful in supplemental oil recovery processes. For these applications, it has been found useful to use the following mass fractions w(Si) of surfactants Si where i stands for 1, 2, or 3, in the surfactant mixtures, the mass fractions being calculated as w(Si)=m(Si)/m(M), m(Si) being the mass of surfactant Si which may be S1, S2, and S3, and m(M) being the mass of the mixture which is equal to the sum of the masses m(S1)+m(S2)+m(S3) of the components:

The mass fraction w(S1) of surfactant S1 in the surfactant mixture is preferably from 20% to 85%, particularly preferably from 25% to 80%, and especially preferred, from 30% to 75%; the mass fraction w(S2) of surfactant S2 in the surfactant mixture is preferably from 10% to 70%, particularly preferably from 13% to 65%, and especially preferred, from 16% to 60%; and the mass fraction w(S3) of surfactant S3 in the surfactant mixture is preferably from 2% to 35%, particularly preferably from 4% to 32%, and especially preferred, from 6% to 30%.

It is further preferred to choose an alkoxylated aliphatic alcohol S3 which has a HLB value of at least 8, more preferred of at least 9, and still more preferred, of at least 10. Particularly good results have been achieved if the HLB value of the surfactant S3 is at least 11.

It has also been found that a minimum of two molecules of ethylene oxide, on average, is needed to provide an alkoxylated aliphatic alcohol having at least ten carbon atoms in the aliphatic alcohol with the desired properties, in the context of this invention.

Combinations of two or more of the preferred embodiments explained herein lead to improved product properties of the surfactant mixtures M.

In addition to the surfactants, it is common practice to use aqueous solvents to enhance the recovery of oil. The aqueous solvents may be water, oilfield brine or synthetic brine made by dissolving sodium chloride in water, in mass fractions of from 1.0% to 6.5%, and adding a mass fraction of 0.05% of calcium chloride. In the examples, the brine solution comprised a mass fraction of dissolved salts of 3.05% whereof the mass fraction of sodium chloride was 3.0%. The model oil used in the examples was dodecane. It is also common to incorporate into the surfactant solutions alkalis, thickening agents and co-solvents. Non-exclusive examples of suitable alkalis are sodium hydroxide, sodium carbonate, sodium silicate, potassium hydroxide, and potassium carbonate. Non-exclusive examples of thickening agents include polymers such as xanthane gum which is a polysaccharide secreted by the bacterium xanthomonas campestris, polyacrylamide or viscoelastic surfactants such as betaines and amine oxides. Non-exclusive examples of suitable co-solvents include low molar mass aliphatic alcohols, glycols, polyglycols, and glycol ethers such as propylene glycol, ethylene glycol, diethylene glycol, ethanol, isopropanol, butanol, iso-butanol, hexanol, 2-ethyl hexanol, octanol and ethylene glycol monobutyl ether.

The mass fraction w(M) of the mixture M of surfactants in the aqueous solution which is used as injection fluid for the process known as “surfactant flooding” where a solution of surfactants is injected into the oil-bearing geological formation, calculated as the ratio of the mass m(M) of the surfactant mixture M, and the mass m(IF) of the aqueous solution which constitutes the injection fluid: w(M)=m(M)/m(IF), is preferably from 0.1% to 5%, particularly preferred, from 0.2% to 3% (from 1 g/kg to 50 g/kg; particularly preferred, from 2 g/kg to 30 g/kg).

It has been found that low interfacial tension is achieved within these ranges, leading to a stable dispersion of oil in the injection fluid that is collected in the production well, and at the same time, low surface tension which leads to good water wetting of the formation rock which is important for a high oil yield.

It has also been found that preferred diester sulfosuccinates, particularly sodium bis-2-ethyl hexyl sulfosuccinate and sodium diamylsulfosuccinate, are inherently and readily bio-degradable, offering advantages over select other chemistries. The majority of the diester sulfosuccinate surfactants possess a water solubility corresponding to mass fractions of dissolved surfactant of 2% or greater, allowing for easy dissolution and incorporation into water based formulations.

Furthermore, by judiciously selecting appropriate co-solvent for the surfactants, one can formulate products with high flash points that improve product handling and increase both operational and worker safety.

It has further been found that mixtures of diester sulfosuccinates S1 and S2 alone, i. e. without addition of further surfactant S3, also show a remarkable synergy in lowering the interfacial tension. The same conditions for the number of carbon atoms as mentioned supra have been found for such binary mixtures. For the best results in lowering the interfacial tension when using dodecane as model oil, the following mass fractions for surfactants S1 and S2 in the mixture of S1 and S2 have been found:

the mass fraction w(S1) of surfactant S1 is from 38% to 90%, preferably from 40% to 87%, and particularly preferred from 42% to 84%, and
the mass fraction w(S2) of surfactant S2 is from 10% to 62%, preferably from 13% to 60%, and particularly preferred from 16% to 58%, the mass fractions being calculated as w(S1)=m(S1)/[m(S1)+m(S2)] and w(S2)=m(S2)/[m(S1)+m(S2)], where m(S1) is the mass of surfactant S1, and m(S2) is the mass of surfactant S2.

In supplemental oil recovery processes, the solution containing the mixtures of surfactants as described hereinabove is injected into so-called injection wells in a hydrocarbon oil containing formation, usually referred to as a reservoir or an “oilfield”, after first conditioning the reservoir with a water preflush. Before, after, or together with, the surfactant mixture solution, a fluid for mobility control can be injected. These fluids are mostly based on aqueous polymer solutions, where polymers such as polyacrylamide, polyethylene oxide, hydroxyethyl cellulose, and polysaccharides are dissolved in water or brine. The oil is then moved towards the production well where it is collected, by injection of water or brine.

In accordance with the above, the invention includes at least the following embodiments:

### Embodiment 1

A surfactant mixture M comprising at least two different sulfosuccinates S1 and S2, wherein S1 has the formula R¹—O—CO—CHX—CHY—CO—O—R², R¹ and R² are linear or branched alkyl groups having independently from each other, from four to six carbon atoms, and S2 has the formula R³—O—CO—CHX—CHY—CO—O—R⁴, where R³ and R⁴ are linear or branched alkyl groups having independently from each other, from seven to forty carbon atoms, and for both formulae independently, X is —H and Y is —SO₃⁻, or Y is —H and X is —SO₃⁻; and an additional surfactant S3 selected from the group consisting of alkoxylated aliphatic alcohols with a HLB value of more than 6.2, wherein the oxyalkylene groups are oxyethylene groups —CH₂—CH₂—O— or oxypropylene groups —CH(CH₃)—CH₂—O—, or mixtures of these, and wherein the alcohol part is a single linear or branched aliphatic alcohol having from eight to forty carbon atoms, or a mixture of at least two of such alcohols.

### Embodiment 2

The surfactant mixture M according to embodiment 1, wherein the mass fraction w(S1) of surfactant S1 in the surfactant mixture is from 20% to 85%; the mass fraction w(S2) of surfactant S2 in the surfactant mixture is from 10% to 70%; and the mass fraction w(S3) of surfactant S3 in the surfactant mixture is from 2% to 35%.

### Embodiment 3

The surfactant mixture M according to any one of embodiment 1 and embodiment 2, wherein the alkyl groups R¹ and R² in S1 are identical, and are selected from the group consisting of n-butyl, 1-methylpropyl, 2-methylpropyl, 1,1-dimethylethyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methypentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, and 2-ethylbutyl.

### Embodiment 4

The surfactant mixture M according to any one of embodiment 1 and embodiment 2 and embodiment 3, wherein the alkyl groups R³ and R⁴ in S2 are identical, and are selected from the group consisting of n-heptyl, n-octyl, 2-ethylhexyl, n-tridecyl, branched tridecyl, and from isomer mixtures of aliphatic linear and branched alcohols having from seven to forty carbon atoms based on fatty alcohols which are made by hydrogenation of fatty acids, by the Guerbet reaction, or from olefins using Ziegler alcohol processes, or the oxo process.

### Embodiment 5

The surfactant mixture M of any one of embodiments 1, 2, 3, and 4, wherein surfactant S3 has an HLB value of at least 6.5.

### Embodiment 6

The surfactant mixture M of any one of embodiments 1 to 5, wherein surfactant S3 has an HLB value of at least 7.

### Embodiment 7

The surfactant mixture M of any one of embodiments 1 to 6, which comprises mixtures of sodium di-(1,3-dimethylbutyl)-sulfosuccinate as S1, and sodium dioctylsulfosuccinate which comprises mostly the 2-ethylhexyl isomer, as S2.

### Embodiment 8

A solution comprising the surfactant mixture M according to any one of embodiments 1 to 7, and a solvent selected from the group consisting of water; an aqueous solution of salts which salts comprise sodium chloride; ethanol, ethylene glycol, propylene glycol, and mixtures of two or more of these.

### Embodiment 9

A method of treating a hydrocarbon oil containing formation comprising injecting, through an injection well, the solution of embodiment 8 into the said formation, and thereafter, injecting water or brine through the said injection well into the said formation, thereby moving the injected solutions and the oil to a production well.

### Embodiment 10

The method of embodiment 9, wherein the mass fraction of the surfactant mixture in the injected solution is from 0.1% to 5%.

The invention is further explained and illustrated in the examples.

### EXAMPLES

The following chemicals and solutions were used in these examples:

A brine solution was prepared by dissolving sodium chloride (Crystal ACS grade, Lot-0000095757, Macron Fine Chemicals) and calcium chloride (Anhydrous, 96% Pure, Lot-A0253415, Acros Organics) in deionised water to form solutions having a mass fraction w(NaCl) of dissolved sodium chloride in the solution of 3% (30 g/kg), and a mass fraction w(CaCl₂) of dissolved calcium chloride of 0.05% (0.5 g/kg) in the solution.

The following surfactants were used in the examples:

A: di(2-ethylhexyl) sulfosuccinate, sodium salt, CAS No. 577-11-7, commercially available from Cytec Industries Inc. as AEROSOL® OT-70 PG as a 70% strength solution

B: di-(1,3-dimethylbutyl) sulfosuccinate, sodium salt, CAS No. 2373-38-8, commercially available from Cytec Industries Inc. as AEROSOL® MA-80 PG as a 80% strength solution

C: poly(oxy-1,2-ethanediyl) isotridecanol ether, with an average of eight oxyethylene units per molecule, having a HLB value of 12.7, CAS No. 9043-35-5, commercially available from Sasol Olefins and Surfactants as Novel® TDA-8

D: poly(oxy-1,2-ethanediyl) linear primary alkyl (C₁₂- to C₁₄— mixture) ether, (Laureth-2), with an average of 1.6 oxyethylene units per molecule, and a hydroxyl value of (210±5) mg/g, as taken from “Industrial Surfactants”, 2nd ed. (Ernest W. Flick), having a HLB value of 6.2, CAS No. 68551-12-2, commercially available from Huntsman as Surfonic® L24-2

E: poly(oxy-1,2-ethanediyl/co-oxy-1-methyl-1,2-ethanediyl) (cetyl alcohol/stearyl alcohol mixture in mass ratio of 30/70) ether, having a HLB value of 6.5, CAS No. 68002-96-0, commercially available from Sasol Olefins and Surfactants as Marlox® RT-42

F: poly(oxy-1,2-ethanediyl) linear primary alkyl (C₁₀- to C₁₆— alcohol mixture) ether, with an average of five oxyethylene units per molecule, having a HLB value of 11.5, CAS No. 68002-97-1, commercially available from Sasol Olefins and Surfactants as Alfonic® C1012-5

G: triethoxylated mixture of linear aliphatic alcohols having from ten to twelve carbon atoms, having a HLB value of 9.0, commercially available from Huntsman as Surfonic® L12-3

H: ethoxylated mixture of linear aliphatic alcohols having from twelve to fourteen carbon atoms, with an average of five oxyethylene units per molecule, having a HLB value of 10.6, commercially available from Huntsman as Surfonic® L24-5

I: ethoxylated mixture of linear aliphatic alcohols having from ten to twelve carbon atoms, with an average of six oxyethylene units per molecule, having a HLB value of 12.4, commercially available from Huntsman as Surfonic® L12-6

J: ethoxylated mixture of linear aliphatic alcohols having from twelve to fourteen carbon atoms, with an average of nine oxyethylene units per molecule, having a HLB value of 13.0, commercially available from Huntsman as Surfonic® L24-9

K: ethoxylated mixture of linear aliphatic alcohols having from ten to twelve carbon atoms, with an average of eight oxyethylene units per molecule, having a HLB value of 13.6, commercially available from Huntsman as Surfonic® L12-8

L: ethoxylated mixture of branched aliphatic alcohols having an average of thirteen carbon atoms, with an average of three oxyethylene units per molecule, having a HLB value of 8.0, commercially available from Sasol Olefins and Surfactants as Novel® TDA-3

M: ethoxylated mixture of branched aliphatic alcohols having an average of thirteen carbon atoms, with an average of nine oxyethylene units per molecule, having a HLB value of 13.2, commercially available from Sasol Olefins and Surfactants as Novel® TDA-9

N: ethoxylated mixture of branched aliphatic alcohols having an average of thirteen carbon atoms, with an average of thirty oxyethylene units per molecule, having a HLB value of 17.4, commercially available from Sasol Olefins and Surfactants as Novel® TDA-30

O: ethoxylated mixture of branched aliphatic alcohols having an average of thirteen carbon atoms, with an average of forty oxyethylene units per molecule, having a HLB value of 18.0, commercially available from Sasol Olefins and Surfactants as Novel® TDA-40

“Strength” is the mass fraction w(X) of solute X in a solution, w(X)=m(X)/m, where m(X) is the mass of solute X, and m is the mass of the solution, usually measured in “%”, or cg/g.

The surfactant solutions were prepared by charging the brine to a flask and adding surfactant to reach a mass fraction w(S) of dissolved surfactant in the solution of 0.5% (5 g/kg), and by mixing the solution for sixty minutes to insure the preparation of a homogeneous solution.

All experiments were conducted with the surfactants incorporated into the aqueous solution at a mass fraction of 0.5% as noted above. For example, when using a surfactant solution of 80% strength, for 100 g of solution, it is needed to add a mass of surfactant solution of 0.5 g*100 g/80 g=0.625 g.

Surface tension measurements were taken on a Kruss K-12 Tensiometer at 25° C. using the Wilhelmy plate method, in accordance with ISO standard 304, equivalent to ASTM D 1331-89.

Interfacial tension measurements were performed on combinations of equal masses of the aqueous brine solutions and of a co-solvent to model the oil. The co-solvent utilised in the experiments as model oil was a pure sample of dodecane (99% purity, anhydrous, Lot-65796EM, Sigma Aldrich). The interfacial tension was measured at a temperature of 25° C., using a Kruss Site 100 Spinning Drop Tensiometer, in accordance with ISO 6889.

HLB stands for Hydrophilic Lipophilic Balance; the HLB value of nonionic surfactants can be calculated according to Griffin, J. Soc. Cosmet. Chem., 5, pages 249 to 256 (1954).

It is important to ensure that the combination of surfactants does not lead to an increase in surface tension. This has been verified by the examples.

### Example 1

Three-component mixtures were prepared from surfactants A, B, and C, and dissolved in brine as detailed supra, at a total surfactant mass fraction w(A)+w(B)+w(C)=0.5%. For comparison, solutions of the pure surfactants A, B, and C were included in the test. For measuring IFT, these surfactant solutions were contacted with n-dodecane in equal masses.

The following data were found for the interfacial tension (IFT) and the surface tension (ST):

TABLE 1

| | w(A) | w(B) | w(C) | m(A)/m(B)/m(C) | IFT | ST |
|---|---|---|---|---|---|---|
| | Unit | | | | | |
| Solution | % | | | | mN/m | |
| 1.1 | 0.5 | 0 | 0 | 100/0/0 | 0.534 | 25.5 |
| 1.2 | 0 | 0.5 | 0 | 0/100/0 | 0.939 | 24.2 |
| 1.3 | 0 | 0 | 0.5 | 0/0/100 | 0.400 | 28.4 |
| 1.4 | 0.36 | 0.09 | 0.05 | 72/18/10 | 0.123 | 25.4 |
| 1.5 | 0.25 | 0.2 | 0.05 | 50/40/10 | 0.025 | 25.3 |
| 1.6 | 0.275 | 0.2 | 0.025 | 55/40/5 | 0.065 | 25.2 |
| 1.7 | 0.25 | 0.225 | 0.025 | 50/45/5 | 0.030 | 25.2 |
| 1.8 | 0.215 | 0.155 | 0.13 | 43/31/26 | 0.020 | 25.2 |
| 1.9 | 0.09 | 0.36 | 0.05 | 18/72/10 | 0.209 | 24.8 |
| 1.10 | 0.195 | 0 | 0.305 | 39/0/61 | 0.121 | 26.9 |

In contact with n-dodecane, the brine solutions of all surfactant mixtures showed much lower interfacial tension than each of the surfactant components alone, and low interfacial tension of below 0.1 mN/m has been obtained in solutions 1.5 to 1.8. No such unexpected synergy has been found in the surface tension of solutions of these mixtures which generally remain between the values of the surfactant components alone, with no surprising effect.

### Example 2

Three-component mixtures were prepared from surfactants A, B, and varying co-surfactants C, D, E, and F, and dissolved in brine as detailed supra, at a total surfactant mass fraction w(A)+w(B)+w(C)+w(D)+w(E)+w(F)=0.5%. For comparison, solutions of the pure surfactants A, B, C, D, E, and F were included in the test. As surfactants C, D, E, and F were used alternatively, they were designated in table 2 by the symbol “X”, and the identity of the third surfactant was clarified in each line of table 2. For measuring IFT, these surfactant solutions were contacted with n-dodecane in equal masses.

The following data were found for the interfacial tension (IFT) and the surface tension (ST):

TABLE 2

| | w(A) | w(B) | w(X) | HLB(X) | m(A)/m(B)/m(X) | IFT | ST |
|---|---|---|---|---|---|---|---|
| So- | Unit | | | | | | |
| lution | % | | | | | mN/m | |
| 2.1 | 0.5 | 0 | 0 | | 100/0/0 | 0.534 | 25.5 |
| 2.2 | 0 | 0.5 | 0 | | 0/100/0 | 0.939 | 24.2 |
| 2.3 | 0 | 0 | 0.5 | 12.7 | 0/0/100; X = C | 0.400 | 28.4 |
| 2.4 | 0 | 0 | 0.5 | 6.2 | 0/0/100; X = D | 0.126 | 21.5 |
| 2.5 | 0 | 0 | 0.5 | 6.5 | 0/0/100; X = E | 0.121 | 29.5 |
| 2.6 | 0 | 0 | 0.5 | 11.5 | 0/0/100; X = F | 0.507 | no data |
| 2.7 | 0.09 | 0.36 | 0.05 | 12.7 | 18/72/10; X = C | 0.209 | 24.8 |
| 2.8 | 0.25 | 0.2 | 0.05 | 12.7 | 50/40/10; X = C | 0.025 | 25.3 |
| 2.9 | 0.09 | 0.365 | 0.045 | 6.2 | 18/73/9; X = D | 0.484 | 25.1 |
| 2.10 | 0.275 | 0.16 | 0.065 | 6.2 | 55/32/13; X = D | 0.121 | 25.4 |
| 2.11 | 0.09 | 0.36 | 0.05 | 6.5 | 18/72/10; X = E | 0.084 | 25.1 |
| 2.12 | 0.25 | 0.20 | 0.05 | 6.5 | 50/40/10; X = E | 0.115 | 25.2 |
| 2.13 | 0.09 | 0.36 | 0.05 | 11.5 | 18/72/10; X = F | 0.165 | no data |
| 2.14 | 0.25 | 0.20 | 0.05 | 11.5 | 50/40/10; X = F | 0.025 | no data |

It can be seen from this table that it is possible to achieve low interfacial tension with mixtures of surfactants A and B, with a third surfactant X which is an alkoxylated alcohol (mixture) if the HLB of this third surfactant is more than 6.2.

It has been found, generally, for third surfactants which are ethoxylated alcohol ethers S3 having an HLB value of more than 6.5, the lowest values for interfacial tension have been obtained for mixtures having mass ratios m(S1): m(S2): m(S3) of (35 to 44): (45 to 54): (2 to 22).

### Example 3

Three-component mixtures were prepared from surfactants A, B, and varying alkoxylated alcohols as co-surfactants D, G, H, F, I, J, and K, and dissolved in brine as detailed supra, at a total surfactant mass fraction w(A)+w(B)+w(X)=0.5%, and identical mass ratios of surfactants A, B, and varying ethoxylated linear alcohol ether surfactants X of m(A)/m(B)/m(X)=50/40/10. As surfactants D, G, H, F, I, J, and K were used alternatively, they were designated in table 3 by the symbol “X”, and the identity of the third surfactant was clarified in each line of table 3, with its HLB value stated. For measuring IFT, these surfactant solutions were contacted with n-dodecane in equal masses. The alcohols used had a number of from ten to twelve carbon atoms, or alternatively, from twelve to fourteen carbon atoms, in the alcohol molecule, n(C)/n(a)=10 to 12, or n(C)/n(a)=12 to 14, and an increasing amount-of-substance fraction x(EO) of oxyethylene groups in the molecule, calculated as x(EO)=n(EO)/n(a), where n(EO) is the amount of substance of oxyethylene (EO) groups, and n(a) is the amount of substance of alcohol in the ethoxylated alcohol. HLB increases with increasing oxyethylene group content, and decreases with a longer carbon chain in the alcohol. For measuring IFT, these surfactant solutions were contacted with n-dodecane in equal masses. The following results were obtained:

TABLE 3

| | n(C)/n(a) | x(EO) | | Surfactant | IFT |
|---|---|---|---|---|---|
| Solution | mol/mol | mol/mol | HLB | Designation | mN/m |
| 3.1 | 12 to 14 | 2 | 6.2 | X = D | 0.121 |
| 3.2 | 10 to 12 | 3 | 9 | X = G | 0.051 |
| 3.3 | 12 to 14 | 5 | 9.4 | X = H | 0.020 |
| 3.4 | 10 to 12 | 5 | 11.5 | X = F | 0.025 |
| 3.5 | 10 to 12 | 6 | 12.4 | X = I | 0.011 |
| 3.6 | 12 to 14 | 9 | 13 | X = J | 0.009 |
| 3.7 | 10 to 12 | 8 | 13.6 | X = K | 0.013 |

It can be seen that low values of less than 0.1 mN/m of the interfacial tension can be realised by admixing a nonionic surfactant of the ethoxylated linear alcohol type having a HLB number of more than 6.2. A minimum for this composition has been reached with solution 3.6 for a HLB value of 13 for the alkoxylated alcohol surfactant, while the solution 3.7 comprising an ethoxylated alcohol having a HLB number of 13.6 shows a very slight rise in IFT with respect to solution 3.6. Therefore, a nonionic surfactant which is an ethoxylated alcohol having a HLB number of more than 6.2 appears to perform best in this combination with surfactants S1 and S2.

### Example 4

Three-component mixtures were prepared from surfactants A, B, and varying co-surfactants according to S3, designated as L, C, M, N, and O, above, and dissolved in brine as detailed supra, at a total surfactant mass fraction w(A)+w(B)+w(X)=0.5%, and identical mass ratios of surfactants A, B, and varying ethoxylated branched alcohol ether surfactants X of m(A)/m(B)/m(X)=50/40/10. As surfactants L, C, M, N, and O were used alternatively, they were designated in table 4 by the symbol “X”, and the identity of the third surfactant was clarified in each line of table 4. For measuring IFT, these surfactant solutions were contacted with n-dodecane in equal masses. The alcohols used had an average number of carbon atoms of thirteen in the branched alcohol molecule, avg [n(C)/n(a)]=13, and an increasing amount-of-substance fraction x(EO) of oxyethylene groups in the molecule, calculated as x(EO)=n(EO)/n(a), where n(EO) is the amount of substance of oxyethylene (EO) groups, and n(a) is the amount of substance of alcohol in the ethoxylated alcohol. For measuring IFT, these surfactant solutions were contacted with n-dodecane in equal masses. The following results were obtained:

TABLE 4

| | n(C)/n(a) | x(EO) | | Surfactant | IFT |
|---|---|---|---|---|---|
| Solution | mol/mol | mol/mol | HLB(X) | Designation | mN/m |
| 4.1 | 13 | 3 | 8.0 | X = L | 0.088 |
| 4.2 | 13 | 8 | 12.7 | X = C | 0.025 |
| 4.3 | 13 | 9 | 13.2 | X = M | 0.018 |
| 4.4 | 13 | 30 | 17.4 | X = N | 0.014 |
| 4.5 | 13 | 40 | 18.0 | X = O | 0.017 |

A minimum in the interfacial tension was observed for x(EO)=30 mol/mol, corresponding to a HLB of 17.4.

### Example 5

A three-component mixture was prepared from surfactants A, B, and alkoxylated alcohol co-surfactant F having a HLB value of 11.5, and dissolved in brines of different salinity, at a total surfactant mass fraction w(A)+w(B)+w(F)=0.5%, and identical mass ratios of surfactants A, B, and varying co-surfactants X of m(A)/m(B)/m(F)=50/40/10. For measuring IFT, this surfactant solution was contacted with n-dodecane in equal masses. Surface tension was measured on the aqueous phase after contacting with n-dodecane. Brines of different salinity were prepared by dissolving sodium chloride (Crystal ACS grade, Lot-0000095757, Macron Fine Chemicals) and calcium chloride (Anhydrous, 96% Pure, Lot-A0253415, Acros Organics) in deionised water to form solutions having a mass fraction w(NaCl) of dissolved sodium chloride in the solution of 1%, 2%, 3%, 4%, 5%, and 6% (10 g/kg, 20 g/kg, 30 g/kg, 40 g/kg, 50 g/kg, and 60 g/kg), and a mass fraction w(CaCl₂) of dissolved calcium chloride of 0.05% (0.5 g/kg) in the brine solution. These brines were designated as B1 through B6. The following results were obtained:

TABLE 5

| | Brine | | | | | |
|---|---|---|---|---|---|---|
| | B1 | B2 | B3 | B4 | B5 | B6 |
| w(NaCl)/(g/kg) | 10 | 20 | 30 | 40 | 50 | 60 |
| w(CaCl₂)/ | 0.5 | 0.5 | 0.5 | 0.5 | 0.5 | 0.5 |
| (g/kg) | | | | | | |
| Surface tension | 25.4 | 25.4 | 25.1 | 25.0 | 25.1 | 25.1 |
| in mN/m | | | | | | |
| Interfacial | 0.018 | 0.011 | 0.025 | 0.052 | 0.100 | 0.139 |
| tension in | | | | | | |
| mN/m | | | | | | |

As can be seen, with these surfactant mixtures of surfactants S1 and S2 in combination with an alkoxylated alcohol S3, having a HLB value of 11.5, low values for interfacial tension of less than 0.1 mN/m can be obtained over a broad range of salinity of from 1.05% up to 4.05%. When using a higher total surfactant concentration of 1%, at the same mass ratio as above, the interfacial tension for brine B5 can be reduced to 0.063 mN/m, and for brine B6, to 0.114 mN/m. This shows that the usefulness of these surfactant combinations is retained over different oil field conditions.

As used herein, the terms “a” and “an” do not denote a limitation of quantity, but rather the presence of at least one of the referenced items. Recitation of ranges of values are merely intended to serve as a shorthand method of referring individually to each separate value falling within the range, and each separate value is incorporated into this specification as if it were individually recited. Thus each range disclosed herein constitutes a disclosure of any sub-range falling within the disclosed range. Disclosure of a narrower range or more specific group in addition to a broader range or larger group is not a disclaimer of the broader range or larger group. All ranges disclosed herein are inclusive of the endpoints, and the endpoints are independently combinable with each other. “Comprises” as used herein includes embodiments “consisting essentially of” or “consisting of” the listed elements.

Although the foregoing description has shown, described, and pointed out the fundamental novel features of certain embodiments of the present invention, it will be understood that various omissions, substitutions, and changes in the form of the detail of the invention as described may be made by those skilled in the art, without departing from the spirit and scope of the present teachings. Consequently, the scope of the present invention should not be limited to the foregoing examples, description or discussion.

What is claimed is:

1. A surfactant mixture M comprising at least two different sulfosuccinates S1 and S2, wherein S1 has the formula R¹—O—CO—CHX—CHY—CO—O—R², R¹ and R² are linear or branched alkyl groups having independently from each other, from four to six carbon atoms, and S2 has the formula R³—O—CO—CHX—CHY—CO—O—R⁴, where R³ and R⁴ are linear or branched alkyl groups having independently from each other, from seven to forty carbon atoms, and for both formulae independently, X is —H and Y is —SO₃⁻, or Y is —H and X is —SO₃⁻; and an additional surfactant S3 selected from the group consisting of alkoxylated aliphatic alcohols with a HLB value of more than 6.2, wherein the oxyalkylene groups are oxyethylene groups —CH₂—CH₂—O— or oxypropylene groups —CH(CH₃)—CH₂—O—, or mixtures of these, and wherein the alcohol part is a single linear or branched aliphatic alcohol having from eight to forty carbon atoms, or a mixture of at least two of such alcohols.

2. The surfactant mixture M according to claim 1, wherein the mass fraction w(S1) of surfactant S1 in the surfactant mixture is from 20% to 85%; the mass fraction w(S2) of surfactant S2 in the surfactant mixture is from 10% to 70%; and the mass fraction w(S3) of surfactant S3 in the surfactant mixture is from 2% to 35%.

3. The surfactant mixture M according to claim 1, wherein the alkyl groups R¹ and R² in S1 are identical, and are selected from the group consisting of n-butyl, 1-methylpropyl, 2-methylpropyl, 1,1-dimethylethyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methypentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, and 2-ethylbutyl.

4. The surfactant mixture M according to claim 1, wherein the alkyl groups R³ and R⁴ in S2 are identical, and are selected from the group consisting of n-heptyl, n-octyl, 2-ethylhexyl, n-tridecyl, branched tridecyl, and from isomer mixtures of aliphatic linear and branched alcohols having from seven to forty carbon atoms based on fatty alcohols which are made by hydrogenation of fatty acids, by the Guerbet reaction, or from olefins using Ziegler alcohol processes, or the oxo process.

5. The surfactant mixture M according to claim 1, wherein surfactant S3 has an HLB value of at least 6.5.

6. The surfactant mixture M according to claim 5, wherein surfactant S3 has an HLB value of at least 7.

7. The surfactant mixture M according to claim 1, which comprises mixtures of sodium di-(1,3-dimethylbutyl)-sulfosuccinate as S1, and sodium dioctylsulfosuccinate which comprises mostly the 2-ethylhexyl isomer, as S2.

8. A solution comprising the surfactant mixture M according to claim 1, and a solvent selected from the group consisting of water; an aqueous solution of salts which salts comprise sodium chloride; ethanol, ethylene glycol, propylene glycol, and mixtures of two or more of these.

9. A method of treating a hydrocarbon oil containing formation comprising injecting, through an injection well, the solution of claim 8 into the said formation, and thereafter, injecting water or brine through the said injection well into the said formation, thereby moving the injected solutions and the oil to a production well.

10. The method of claim 9, wherein the mass fraction of the surfactant mixture in the injected solution is from 0.1% to 5%.
